(19) United States
(12) Patent Application Publication
(10) Pub. No.: US 2010/0253630 A1
(43) Pub. Date: Oct. 7, 2010

(54) INPUT DEVICE AND AN INPUT PROCESSING METHOD USING THE SAME

(76) Inventors: Fuminori HOMMA, Tokyo (JP); Tatsushi NASHIDA, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/750,130

(22) Filed: Mar. 30, 2010

(30) Foreign Application Priority Data
Apr. 6, 2009 (JP) P2009-092403

(51) Int. Cl. G06F 3/02

(52) U.S. Cl. 345/168

(57) ABSTRACT

Disclosed herein is an input device, including: a manipulating block including an electrostatic capacitance detecting portion configured to detect a proximal distance to a manipulating body in accordance with a change in electrostatic capacitance; a shape detecting portion configured to detect an effective area; a determining portion configured to determine whether or not a key which the manipulating body contacts is depressed for a predetermined period of time; and a display processing portion configured to move an object being displayed on a display portion.

### BACKGROUND OF THE INVENTION

1. Field of the Invention

The present invention relates to an input device and an input processing method using the same, and more particularly to an input device with which both key input and a pointing manipulation can be carried out, and an input processing method using the same.

2. Description of the Related Art

Heretofore, in a computer using a mouse device as a pointing device, a pointing manipulation is carried out by moving the mouse device itself. For this reason, a space for a movement of the mouse device needs to be ensured. In addition, in a compact computer typified by a notebook-sized personal computer (PC), a mouse pad is provided in a part of the computer, and thus the pointing manipulation can be carried out by moving a finger of a user on the mouse pad. In recent years, however, the apparatus has been further miniaturized, for example, as with a mobile PC. As a result, it has been physically different to ensure the space for the mouse pad.

In order to cope with such a problem, for example, Japanese Patent Laid-Open No. 2007-18421 (hereinafter referred to as Patent Document 1) discloses a keyboard with a pointing device function in which planar touch pads are provided on key tops of keys disposed in the keyboard. By using such a keyboard, a mouse manipulation can be carried out by contact between the finger or the palm of the hand of the user, and the desired touch pad, and thus a manipulability of key input can be enhanced. However, with the technique disclosed in Patent Document 1, since elements for touch sensors are provided on the key tops, respectively, the number of elements for the touch sensors, and positions, in disposition, thereof depend on the number of keys and the positions of the keys. For this reason, there is caused such a problem that there is a restriction to the number of elements for the touch sensors, and the positions, in disposition, thereof.

On the other hand, a technique for providing a key sheet disclosed in Japanese Patent Laid-Open No. 2008-117371 (hereinafter referred to as Patent Document 2) between the key tops and the keyboard, for example, is expected as a technique for carrying out the pointing manipulation in accordance with a motion of the hand on the keyboard without disposing the elements for the touch sensors on the key top side. The key sheet disclosed in Patent Document 2, for example, as shown in FIG. 16, is applied as a sensor section 20 of a display panel 10 of a proximal detection type information display device.

The display panel 10, as shown in FIG. 16, is structured by sticking a protective plate 14 onto a back surface of a two-dimensional display section 12, for example, composed of a liquid crystal display element or an organic EL element, and by providing the sensor section 20 as the key sheet on a surface of the two-dimensional display section 12. In the sensor section 20, glass plates 24 and 26 are provided on both surfaces of an electrode 22 composed of a plurality of wire electrodes disposed in a matrix, respectively. In the wire electrodes composing the electrode 22, high-frequency signals are alternately applied every wire electrodes disposed in the same direction through terminals derived from the glass plate 26. As a result, the sensor section 20 functions as an electrostatic capacitance type touch sensor. Such a sensor section 20 can detect a distance L between, for example, a hand H as a manipulating body and a surface 10a of the display panel 10 by detecting a change in electrostatic capacitance.

### SUMMARY OF THE INVENTION

However, for example, in the case of the technique, for providing the key sheet, disclosed in Patent Document 2, between the key tops and the keyboard, although the motion of the hand on the keyboard can be detected, it may be impossible to discriminate whether or not a user intentionally carries out the motion for the pointing manipulation. For this reason, there is encountered such a problem that even when the user depresses the desired key, a pointing cursor responds to the depressing operation, which results in that the manipulability of the key input is reduced. Therefore, such a technique cannot be applied as such a use application that the motion of the hand on the keyboard is roughly detected to be recognized as a gesture.

The present invention has been made in order to solve the problems described above, and it is therefore desirable to provide a novel improved input device which is capable of including a pointing device function without reducing a manipulability of key input, and an input processing method using the same.

In order to attain the desire described above, according to an embodiment of the present invention, there is provided an input device including: a manipulating block including an electrostatic capacitance detecting portion configured to detect a proximal distance to a manipulating body in accordance with a change in electrostatic capacitance, the electrostatic capacitance detecting portion being provided between a base and a plurality of keys composed of conductive members disposed on the base and being electrically connected to each of the plurality of keys; a shape detecting portion configured to detect an effective area having an electrostatic capacitance having a value equal to or larger than a predetermined value in accordance with an electrostatic capacitance value detected by the electrostatic capacitance detecting portion, and detect a shape of the key having data stored in advance from the effective area; a determining portion configured to determine whether or not the key which the manipulating body contacts is depressed for a period of time equal to or longer than a predetermined period of time when the shape of the key is detected from the effective area by the shape detecting portion; and a display processing portion configured to move an object being displayed on a display portion in accordance with a motion of the manipulating body which contacts a surface of the manipulating block to move when the key is not depressed for the period of time equal to or longer than the predetermined period of time.

According to the embodiment of the present invention, when the manipulating body contacts the surface of the manipulating block, and the key is not depressed for the period of time equal to or longer than the predetermined period of time, the input device with which the key input can be carried out by using the plurality of keys disposed on the base is made to function as a manipulating section for moving the object being displayed on the display portion. As a result, the space saving for the input device can be promoted without reducing the manipulability of the key input.

Here, the input device according to the embodiment of the present invention can also include a center-of-gravity position calculating portion configured to calculate a position of a center of gravity of the effect area, and a movement amount calculating portion configured to calculate a movement amount of position of the center of gravity. At this time, the display processing portion moves the object being displayed on the display portion in accordance with the movement amount thus calculated.

In addition, the shape detecting portion can also further detect a shape of the manipulating body from the effective area. At this time, the center-of-gravity position calculating portion may calculate a position of a center of gravity in the shape portion, of the manipulating body, of the effective area.

Moreover, the input device according to the embodiment of the present invention can also include an inclination determining portion configured to determine a degree of inclination of the manipulating body with respect to the surface of the manipulating block from the shape of the manipulating body detected by the shape detecting portion. At this time, the display processing portion moves the object being displayed on the display portion in accordance with a motion of the manipulating body which contacts the surface of the manipulating block to move when the inclination determining portion determines that the inclination of the manipulating body with respect to the surface of the manipulating block has a value equal to or smaller than a predetermined value.

In addition, the input device according to the embodiment of the present invention can also include a gesture recognizing portion configured to recognize a gesture from a change in state of the manipulating body acquired from detection results obtained in the electrostatic capacitance detecting portion and the shape detecting portion, respectively, and a gesture storing portion configured to store therein data on the gesture and data on manipulation contents in accordance with which contents being displayed on the display portion are manipulated in relation to each other. At this time, when the gesture recognizing portion recognizes the gesture from the change in state of the manipulating body, the gesture recognizing portion acquires the data on the manipulation contents corresponding to the gesture thus recognized from the gesture storing portion, and outputs the data on the manipulation contents thus acquired to the display processing portion. Also, the display processing portion processes the contents being displayed on the display portion in accordance with the data on the manipulation contents inputted thereto from the gesture recognizing portion.

Moreover, the shape detecting portion can detect the number of manipulating bodies each contacting the surface of the manipulating block. At this time, the display processing portion can change a processing mode when the object being displayed on the display portion is moved in accordance with the number of manipulating bodies detected by the shape detecting portion.

According to another embodiment of the present invention, there is provided an input processing method including the steps of: detecting an electrostatic capacitance by an electrostatic capacitance detecting portion configured to detect a proximal distance to a manipulating body in accordance with a change in electrostatic capacitance, the manipulating body either coming close to or contacting a surface of a manipulating block including the electrostatic capacitance detecting portion provided between a base and a plurality of keys composed of conductive members disposed on the base and electrically connected to each of the plurality of keys, thereby changing the electrostatic capacitance; detecting an effective area having the electrostatic capacitance having a value equal to or larger than a predetermined value in accordance with the value of the electrostatic capacitance detected by the electrostatic capacitance detecting portion; detecting a shape of the key having data stored in advance from the effective area; determining whether or not when the shape of the key is detected from the effective area, the key which the manipulating body contacts is depressed for a period of time equal to or longer than a predetermined period of time; and moving an object being displayed on a display portion in accordance with a motion of the manipulating body which contacts the surface of the manipulating block to move when the key is not depressed for the period of time equal to or longer than the predetermined period of time.

As set forth hereinabove, according to the present invention, it is possible to provide the input device which is capable of including the pointing device function without reducing the manipulability of the key input, and the input processing method using the same.

### BRIEF DESCRIPTION OF THE DRAWINGS

FIG. 1 is an explanatory view showing a schematic configuration of a part of an input device according to an embodiment of the present invention;

FIG. 2 is an explanatory view showing electronic capacitances which are detected by an electrostatic sensor of the input device according to the embodiment of the present invention;

FIG. 3 is a block diagram showing a hardware configuration of an information processor according to the embodiment;

FIG. 4 is a block diagram showing a hardware configuration of the input device according to the embodiment of the present invention;

FIG. 5 is a functional block diagram showing a functional configuration of the information processor to which the input device according to the embodiment of the present invention is connected;

FIG. 6 is a flow chart showing a cursor manipulating method using the input device according to the embodiment of the present invention;

FIG. 7 is an explanatory view showing a motion of a manipulating body, and a movement of a cursor according to the motion of the manipulating body;

FIG. 8 is a flow chart showing a manipulating method corresponding to a state of the manipulating body in the embodiment of the present invention;

FIG. 9 is an explanatory view showing a state of electrostatic capacitances in a state in which a finger lies on a surface of a manipulating block;

FIG. 10 is an explanatory view showing a state of electrostatic capacitances in a state in which the finger is held up;

FIG. 11 is an explanatory view showing a state of electrostatic capacitances in a state in which the finger is rotated;

FIGS. 12A to 12G are respectively explanatory diagrams showing examples of a gesture;

FIG. 13 is an explanatory diagram showing an example of display of the cursor in a phase of a gesture mode;

FIGS. 14A to 14D are respectively explanatory diagrams showing display of the cursor in a phase of a cursor mode;

FIG. 15 is an explanatory diagram showing an example of display of the cursor in the phase of the cursor mode; and

FIG. 16 is a schematic cross sectional view showing a structure of a display panel as a main body portion of an existing proximal detection type information display device.

### DETAILED DESCRIPTION OF THE PREFERRED EMBODIMENTS

The preferred embodiments of the present invention will be described in detail hereinafter with reference to the accompanying drawings. It is noted that in this specification and the drawings, constituent elements having substantially the same functional compositions are designated by the same reference numerals, respectively, and a repeated description thereof is omitted here for the sake of simplicity.

It is noted that the description will now be given in accordance with the following order.

1. Configuration of Input Device (Schematic Construction of Input Device, Hardware Configuration, Functional Configuration)

2. Input Processing Method Using Input Device (Cursor Manipulating Method, Manipulating Method Corresponding to State of Manipulating Body)

### 1. Configuration of Input Device

### Schematic Construction of Input Device

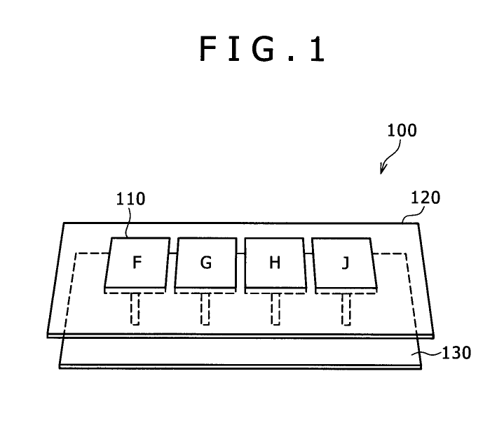

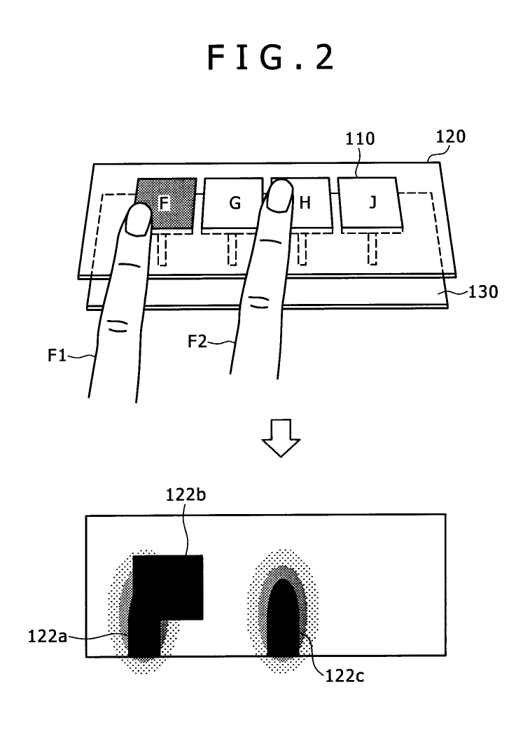

Firstly, a schematic construction of an input device 100 according to an embodiment of the present invention will be described with reference to FIGS. 1 and 2. Note that, FIG. 1 is an explanatory view showing a schematic construction of a part of the input device 100 according to the embodiment of the present invention. Also, FIG. 2 is an explanatory view showing electrostatic capacitances which are detected by an electrostatic sensor of the input device 100 according to the embodiment of the present invention.

The input device 100 of the embodiment is a keyboard having a plurality of keys 110 disposed therein. The input device 100 is used not only as an input section configured to input information by depressing the desired key 110, but also as a manipulating section configured to manipulate, for example, a cursor as an object which is displayed on a display portion.

As shown in FIG. 1, the input device 100 includes an electrostatic capacitance type touch sensor 120 which is disposed between a plurality of keys 110 and a keyboard 130 and which can detect a proximal distance to a manipulating body. The electrostatic capacitance type touch sensor 120 is disposed between a plurality of keys 110 disposed on the keyboard 130 and the keyboard 130, and is electrically connected to each of the keys 110. The sensor section, for example, described in Patent Document 2 can be used in the touch sensor 120. The touch sensor 120 includes electrostatic sensors disposed in a matrix (for example, in a matrix of 10×7), and detects values of electrostatic capacitances from changes in electrostatic capacitances on a steady basis. When a finger as the manipulating body either comes close to or touches corresponding one of the electrostatic sensors, the electrostatic capacitance detected by the corresponding one of the electrostatic sensors increases. An interaction such as a tap manipulation can be carried out in accordance with a change in increase amount of electrostatic capacitance.

In addition, the electrostatic capacitances of the electrostatic sensors can be simultaneously acquired. Changes in electrostatic capacitances of all the electrostatic sensors are simultaneously detected and interpolated, thereby making it possible to detect a shape of the finger which either comes close to or contacts the corresponding one of the electrostatic sensors. In addition, each of the keys 110 of the input device 100 of the embodiment is made of a conductive material such as aluminum or an ITO (Indium Tin Oxide) film. For this reason, when the manipulating body such as the finger contacts the desired key 110 of the keys 110, the electrostatic capacitance of the key portion increases to get approximately a uniform value because the desired key 110 of the keys 110 is electrically connected to the touch sensor 120. As a result, the shape of the desired key 110 of the keys 110 which the manipulating body contacts can also be detected by the electrostatic sensors.

For example, when as shown in FIG. 2, a finger F1 contacts an “F” key 110, as shown in a lower part of FIG. 2, a shape 122a of the finger F1 coming close to the touch sensor 120, and a shape 122b of the key 110 which the finger F1 contacts are both detected in the form of an effective area having a high electrostatic capacitance. In addition, in a state in which a finger F2 comes close to another key 110, as shown in the lower part of FIG. 2, only a shape 122c of the finger F2 is detected in the form of an effective area having a high electrostatic capacitance. In such a manner, whether or not the manipulating body contacts the desired key 110 can be determined in accordance with whether or not the shape of the key 110 exists in the effective area having the high electrostatic capacitance.

In the embodiment, such an input device 100 is normally used as the input section for key input, while it is used as the manipulating section such as a cursor being displayed on the display portion in a state in which the manipulating body contacts the key 110 and does not depress the key 110. As a result, a special input section needs not to be provided for a pointing manipulation, and thus the pointing manipulation can be carried out without reducing manipulability of the key input. In the following, a configuration of the input device 100 of the embodiment and a function thereof will be described in detail.

### Hardware Configuration

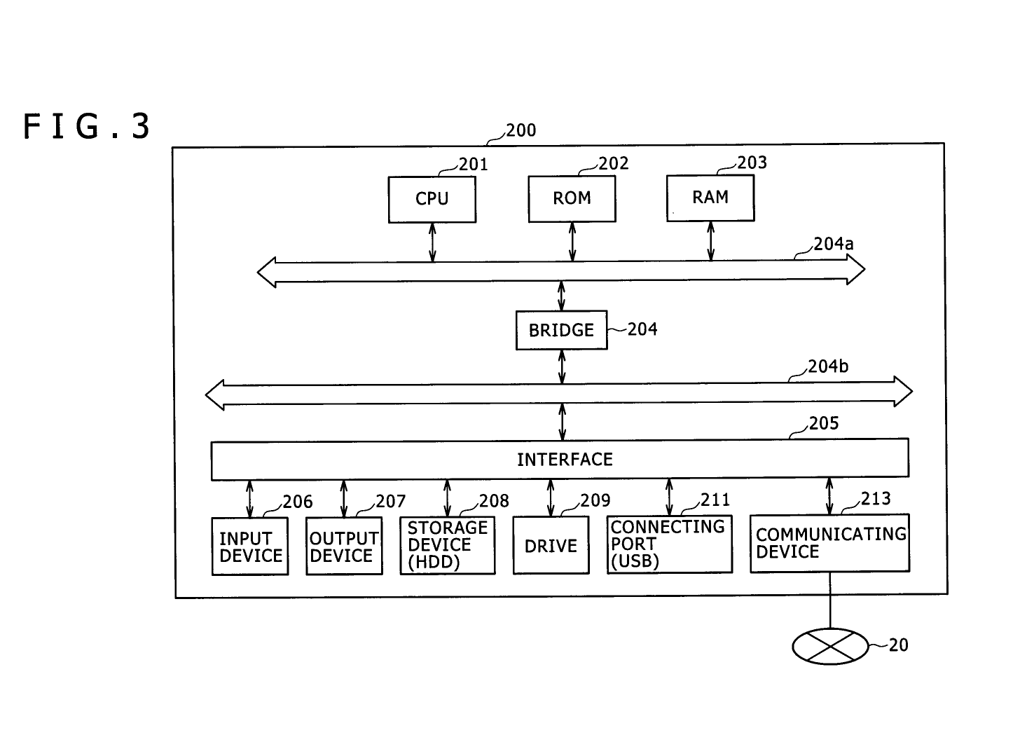

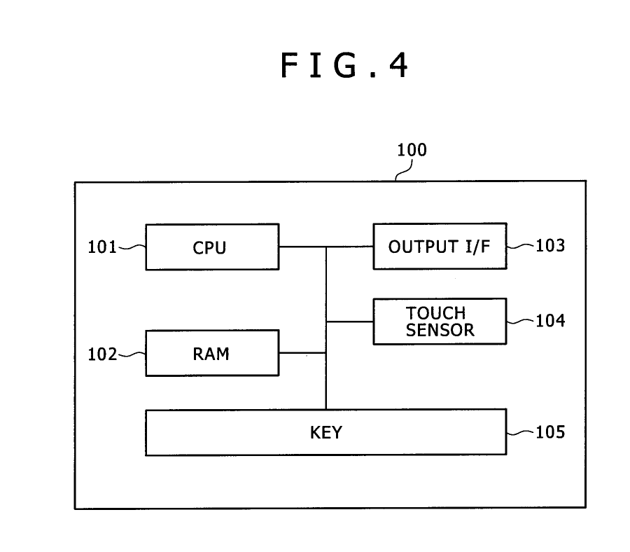

Firstly, a hardware configuration of an information processor 200 including the input device 100 according to the embodiment of the present invention will be described with reference to FIGS. 3 and 4. Note that, FIG. 3 is a block diagram showing the hardware configuration of the information processor 200 of the embodiment. Also, FIG. 4 is a block diagram showing a hardware configuration of the input device 100 of the embodiment. The information processor 200, for example, is a notebook-sized personal computer, a mobile PC or the like.

The information processor 200 of the embodiment includes a Central Processing Unit (CPU) 201, a Read Only Memory (ROM) 202, a Random Access Memory (RAM) 203, and a host bus 204a. In addition, the information processor 200 includes a bridge 204, an external bus 204b, an interface 205, an input device 206, an output device 207, a storage device (HDD: Hard Disk Drive) 208, a drive 209, a connecting port 211, and a communicating device 213.

The CPU 201 functions as each of an arithmetic processing unit and a control unit, and controls the entire operation of the information processor 200 in accordance with various kinds of programs. In addition, the CPU 201 may also be configured in the form of a microprocessor. The ROM 202 stores therein the programs, arithmetic parameters and the like which the CPU 201 uses. The RAM 203 temporarily stores therein the programs which are used in execution by the CPU 201, the parameters which suitably change in execution of the programs, and the like. The CPU 201, the ROM 202, and the RAM 203 are connected to one another through the host bus 204a composed of a CPU bus or the like.

The host bus 204a is connected to the external bus 204b such as a Peripheral Component Interconnect/Interface (PCI) through the bridge 204. It should be noted that the host bus 204a, the bridge 204 and the external bus 204b are not necessarily configured separately from one another, and the functions of the host bus 204a, the bridge 204 and the external bus 204b may also be mounted in one bus.

The input device 206 is composed of an input section, such as a mouse, a keyboard, a touch panel, buttons, a microphone, a switch, and a lever, with which a user inputs information, an input control circuit configured to generate an input signal in accordance with input made by the user, and output the input signal thus generated to the CPU 201, and the like. The user who possesses the information processor 200, for example, can input various kinds of data to the information processor 200, and instructs the information processor 200 to execute the desired processing operation by manipulating the input device 206. In the information processor 200, the input device 100 shown in FIG. 1 is provided as the input device 206.

The input device 100 of the embodiment, as shown in FIG. 4, is composed of a CPU 101, a RAM 102, an output interface (output I/F) 103, a touch sensor 104, and keys 105. The CPU 101 functions as both an arithmetic processing unit and a control unit, and controls the entire operation of the input device 100 in accordance with various kinds of programs. The RAM 102 temporarily stores therein the programs which are used in execution by the CPU 101, the parameters which suitably change in execution of the programs, and the like. The output I/F 103 is a connecting portion configured to connect the input device 100 to a host side, and, for example, is a Universal Serial Bus (USB). The touch sensor 104 is a sensor for detecting that the manipulating body either comes close to or contacts the desired key 105, and corresponds to the touch sensor 120 shown in FIG. 1. As previously stated, the electrostatic sensor is used as the touch sensor 104 in the embodiment. The keys 105 are an input portion with which information is inputted, and corresponds to the keys 110 shown in FIG. 1. By depressing the desired key 105 of those keys 105, information associated with the desired key 105 is outputted to the host side through the output I/F 103.

Referring back to FIG. 3 again, the output device 207, for example, includes a display device such as a Cathode Ray Tube (CRT), a liquid crystal display (LCD) device, an Organic Light Emitting Diode (OLED) device or a lamp. In addition, the output device 207 includes a sound outputting device such as a speaker or a headphone.

The storage device 208 is a device for data storage as an example of a storage portion of the information processor 200. The storage device 208 may include a storage medium, a recording device for recording data in the storage medium, a reading device for reading out data from the storage medium, a deleting device for deleting the data recorded in the recording medium, and the like. The storage device 208, for example, is composed of a Hard Disk Drive (HDD). The storage device 208 drives a hard disk, thereby storing therein programs which are executed by the CPU 101, and various kinds of data.

The drive 209 is a reader/writer for the storage medium, and is either built in or externally provided in the information processor 200. The drive 209 reads out information recorded in a removable recording medium, such as a magnetic disk, an optical disk, a magneto optical disk or a semiconductor memory, with which the drive 209 is equipped, and outputs the information thus read out to the RAM 203.

The connecting port 211 is an interface connected to an external apparatus, and, for example, is a connecting port to the external apparatus through which data can be transmitted via the USB or the like. In addition, the communicating device 213, for example, is a communicating interface which is composed of a communicating device and the like and which is provided for connection to a communication network 20. In addition, the communicating device 213 may be any of a wireless Local Area Network (LAN) response communicating device, a wireless USB response communicating device, or a wired communicating device which carries out a wired communication.

### Functional Configuration

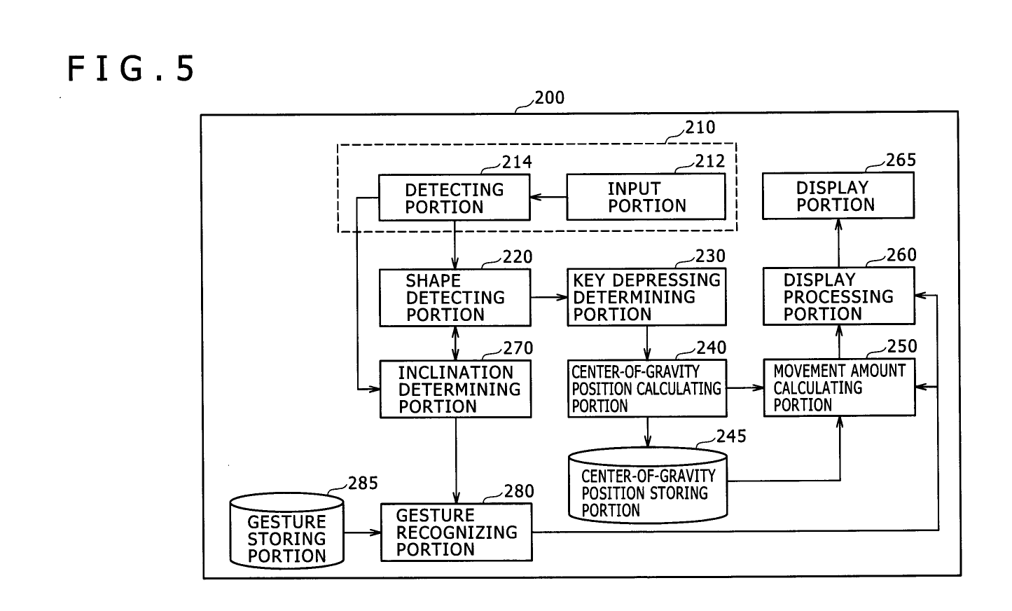

The hardware configuration of the information processor 200 and the input device 100 of the embodiment which is connected to the information processor 200 to be used have been described so far. Next, a description will now be given with respect to a functional configuration of the information processor 200 to which the input device 100 of the embodiment is connected with reference to FIG. 5. It is noted that FIG. 5 is a functional block diagram showing a functional configuration of the information processor 200 to which the input device 100 of the embodiment is connected. Also, FIG. 5 shows only functional portions which are caused to function as sections for carrying out a pointing manipulation by using the input device 100, and functional portions associated with those functional portions.

The information processor 200, as shown in FIG. 5, includes a manipulating block 210, a shape detecting portion 220, a key depressing determining portion 230, a center-of-gravity position calculating portion 240, and a center-of-gravity position storing portion 245. Also, the information processor 200 includes a movement amount calculating portion 250, a display processing portion 260, a display portion 265, an inclination determining portion 270, a gesture recognizing portion 280, and a gesture storing portion 285.

The manipulating block 210 is a functional portion configured to input information by depressing a desired key, and carry out the pointing manipulation for moving a cursor being displayed on the display portion 265. The manipulating block 210 is composed of an input portion 212, and a detecting portion 214. The input portion 212 is a functional portion configured to input information, and corresponds to the keys 110 of the input device 100 shown in FIG. 1. The detecting portion 214 is a functional portion configured to determine whether or not the manipulating body either comes close to or contacts the input surface of the input portion 212. The detecting portion 214 corresponds to the touch sensor 120 shown in FIG. 1, and detects a distance between the manipulating body and the input portion 212 in accordance with a value of an electrostatic capacitance. The detecting portion 214 outputs data on the distance between the manipulating body and the input portion 212 as a detection result obtained therein to each of the shape detecting portion 220 and the inclination determining portion 270.

The shape detecting portion 220 detects a shape of an effective area having an electrostatic capacitance having a value equal to or larger than a predetermined value in accordance with the detection result inputted thereto from the detecting portion 214. The value of the electrostatic capacitance detected by the detecting portion 214 becomes large as the manipulating body comes closer to the input portion 212. By utilizing this feature, the shape detecting portion 220 can specify the effective area having the electrostatic capacitance having the value equal to or larger than the predetermined value. The shape detecting portion 220 detects the shape of the manipulating body, the shape of the key concerned, and the like from the effective area thus specified, and outputs the data on the result of the detection about those shapes to each of the key depressing determining portion 230 and the inclination determining portion 270.

The key depressing determining portion 230 determines whether or not the desired key as a part of the input portion 212 is depressed by the manipulating body. The key depressing determining portion 230 determines whether or not the desired key is depressed for the purpose of determining whether the input portion 212 is used as a section for the information input made by depressing the desired key or as a section for carrying out the pointing manipulation. The key depressing determining portion 230 outputs the result of the determination about whether or not the desired key is depressed to the center-of-gravity position calculating portion 240.

The center-of-gravity position calculating portion 240 calculates a position of the center of gravity of the manipulating body which either comes close to or approaches the input surface of the input portion 212. The center-of-gravity position calculating portion 240 functions when the input portion 212 is used as the section for carrying out the pointing manipulation, and thus, for example, calculates the position of the center of gravity of the manipulating body from the shape of the manipulating body detected by the shape detecting portion 220. The center-of-gravity position calculating portion 240 records data on the position of the center of gravity thus calculated in the center-of-gravity position storing portion 245, and outputs the data on the position of the center of gravity thus calculated to the movement amount calculating portion 250.

The center-of-gravity position storing portion 245 stores therein the data on the position of the center of gravity calculated by the center-of-gravity position calculating portion 240 with time. The data on the positions of the centers of gravities at the respective times stored by the center-of-gravity position storing portion 245 is referred by the movement amount calculating portion 250, and is used for calculation for the movement amount of the cursor or the like manipulated by carrying out the pointing manipulation for moving the cursor or the like.

The movement amount calculating portion 250 calculates the movement amount of the cursor or the like manipulated by carrying out the pointing manipulation. The movement amount calculating portion 250 calculates both a movement direction and a movement amount of the cursor being displayed on the display portion 265 from both the current position of the center of gravity of the manipulating body, and the position of the center of gravity of the manipulating body at the last time, and outputs both data on the movement direction and data on the movement amount to the display processing portion 260.

The display processing portion 260 executes display processing for the cursor being displayed on the display portion 265 in accordance with both the data on the movement direction and the data on the movement amount which have been calculated by the movement amount calculating portion 250. The display processing portion 260 outputs the result about the display processing executed for the cursor in the form of display information to the display portion 265. The display portion 265 displays thereon the cursor in accordance with the display information inputted thereto from the display processing portion 260. In addition, the display processing portion 260 executes display processing for the display portion 265 in accordance with data on manipulation contents inputted thereto from the gesture recognizing portion 280. It should be noted that the display portion 265 corresponds to the output device 207 shown in FIG. 3, and thus, for example, the display device such as the CRT display device, the liquid crystal display device, or the OLED device can be used as the display portion 265.

The inclination determining portion 270 determines the inclination of the manipulating body with respect to the input surface of the input portion 212. The shape of the manipulating body which is detected by the detecting portion 214 changes depending on the inclination of the manipulating body with respect to the input surface of the input portion 212. By utilizing such characteristics, the inclination determining portion 270 specifies the shape of the manipulating body from both the detection result obtained in the detecting portion 214, and the detection result obtained in the shape detecting portion 220, thereby making it possible to determine the inclination of the manipulating body with respect to the input surface of the input portion 212. The inclination determining portion 270 outputs data on the detection result obtained therein to the gesture recognizing portion 280.

The gesture recognizing portion 280 recognizes a gesture being made by the user from the motion of the manipulating body. When the gesture recognizing portion 280 recognizes the gesture, the gesture recognizing portion 280 acquires data on a manipulation corresponding to the gesture thus recognized from the gesture storing portion 285, and outputs the data on the manipulation corresponding to the gesture thus recognized to each of the movement amount calculating portion 250 and the display processing portion 260. The gesture storing portion 285 is a storage portion configured to store therein the data on the gesture and the data on the manipulation contents in relation to each other. The information stored in the gesture storing portion 285 can be set in advance, or both the data on the gesture, and the data on the manipulation contents on the host side can be stored in the gesture storing portion 285 in relation to each other.

In the embodiment, of those functional portions, the function portions other than the display processing portion 260 and the display portion 265 are included in the input device 100. It should be noted that the present invention is by no means limited to such a case, and, for example, the movement amount calculating portion 250, the gesture recognizing portion 280, and the gesture storing portion 285 may be provided on the host side instead.

The functional configuration of the information processor 200 has been described so far. In the input device 100 of the embodiment, as has been described, the manipulating block 210 can be used not only as the input section for inputting the information by depressing the desired key, but also as the manipulating section for carrying out the pointing manipulation for moving the cursor being displayed on the display portion 265. At this time, since the pointing manipulation is carried out by using the manipulating block 210 without reducing the manipulability of the key input, the pointing manipulation can be carried out only when the manipulating body contacts the desired key as the input portion 212, and does not depress the desired key. That is to say, the manipulating body is caused to contact the surface of the manipulating block having a plurality of keys disposed thereon, and the manipulating body is moved in a state in which the manipulating body is caused to contact the surface of the manipulating block, thereby making it possible to move the cursor being displayed on the display portion 265.

### 2. Input Device and Input Processing Method

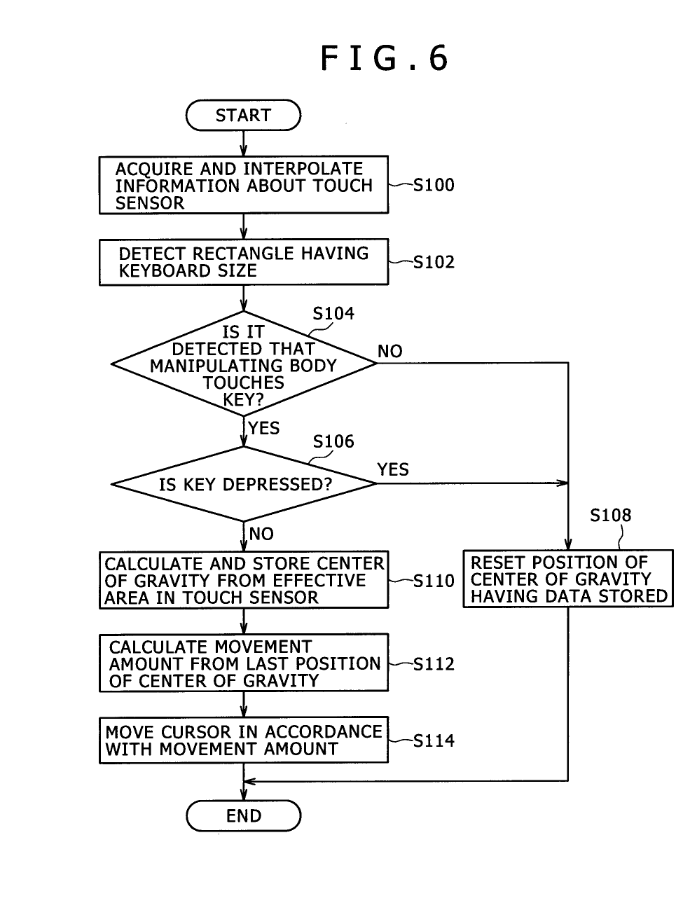

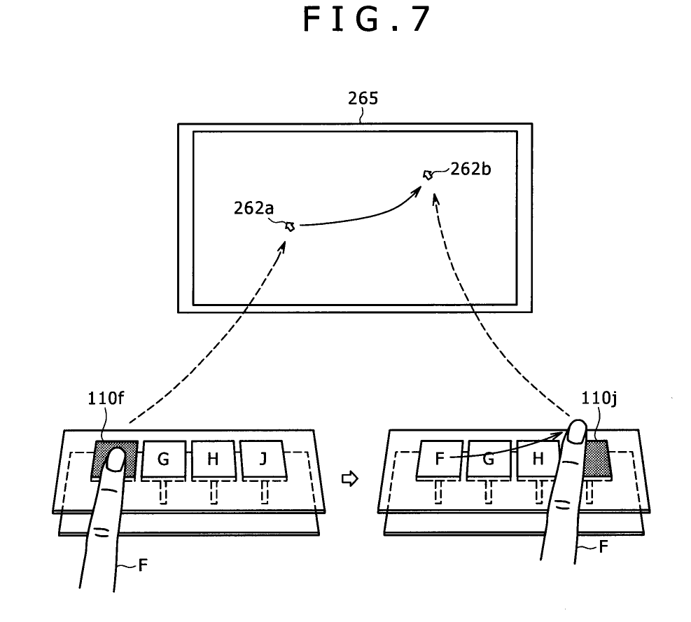

Hereinafter, a cursor manipulating method using the input device 100 according to the embodiment of the present invention will be described in detail with reference to FIGS. 6 and 7. Here, the cursor manipulating method using the input device 100 according to the embodiment of the present invention is another embodiment of the present invention. Note that, FIG. 6 is a flow chart showing the cursor manipulating method using the input device 100 of the embodiment. Also, FIG. 7 is an explanatory view showing an operation of the manipulating body, and a cursor movement by the operation of the manipulating body.

### Cursor Manipulating Method

The cursor manipulation using the input device 100 of the embodiment can be carried out by activating an application for carrying out the pointing manipulation by using the input device 100 on the host side of the information processor 200. When the application has been activated, a thread for continuously monitoring a change in electrostatic capacitance of the touch sensor 120 is created. During this operation, firstly, the shape detecting portion 220 acquires the information from the touch sensor 120 and interpolates the information thus acquired (Step S100). The touch sensor 120 is provided with a plurality of electrostatic sensors. In Step S100, the shape detecting portion 220 acquires the electrostatic capacitances detected by the electrostatic sensors, respectively, and compares the electrostatic capacitances thus detected with the electrostatic capacitances in the phase of activation of the application to calculate differences between the electrostatic capacitances thus detected and the electrostatic capacitances in the phase of activation of the application, thereby interpolating the differences thus calculated so as to obtain an arbitrary resolution capability. The resolution capability, for example, is determined so as to correspond to a resolution of the display portion 265. As a result, there is created two-dimensional information representing a distribution of the values of the electrostatic capacitances as shown in the lower part of FIG. 2.

Next, the shape detecting portion 220 detects the shape of the desired key from the two-dimensional information created in Step S100 (S102). Data on the shapes of the keys, and data on the sizes of the keys in the input device 100 are set in the input device 100 in advance. For example, the data on a rectangle, and the data on a length of one side of about 12 mm are stored as the shape of the key, and the size of the key in a storage portion (not shown). The shape detecting portion 220 detects whether or not the data on the shape of the desired key, and the data on the size of the desired key which are set in advance exist from the two-dimensional information. When the shape detecting portion 220 detects the shape agreeing with the shape and its size of the desired key both the data of which is set in advance from the two-dimensional information, the shape detecting portion 220 determines that the manipulating body contacts the desired key (YES in Step S104), and instructs the key depressing determining portion 230 to determine whether or not the desired key has been depressed (Step S106).

On the other hand, when the shape detecting portion 220 does not detect the shape agreeing with the shape and its size of the desired key both the data of which is set in advance from the two-dimensional information, the shape detecting portion 220 determines that the manipulating body does not contact the desired key (NO in Step S104), and determines that the current state is not a state in which the pointing manipulation should be carried out. Therefore, when the position of the center of gravity the data on which is stored in advance exists, the data on the position of the center of gravity of the manipulating body is reset (Step S108) to complete the processing concerned, and the processing is started to be executed again from Step S100.

Returning back to Step S106, the key depressing determining portion 230 determines whether or not the desired key has been depressed for a predetermined period of time from a time point when the shape agreeing with the shape and its size of the desired key both the data of which is set in advance from the two-dimensional information in Step S104. Also, when the depressing of the desired key is not detected for the predetermined period of time, it is determined that the user intends to carry out the pointing manipulation by the input device 100, and processing for calculating the movement amount of cursor in and after processing of Step S110 is started to be executed. On the other hand, when the depressing of the desired key has been detected for the predetermined period of time, it is determined that the user intends not to carry out the pointing manipulation, but to carry out the key input. Therefore, when the position of the center of gravity the data on which is stored in advance exists, the data on the position of the center of gravity of the manipulating body is reset (Step S108) to complete the processing concerned, and the processing is started to be executed again from Step S100.

When the depressing of the desired key has not been detected for the predetermined period of time in Step S106 (NO in Step S106), the center-of-gravity position calculating portion 240 calculates the position of the center of gravity of the manipulating body from the effective area based on the two-dimensional information created based on the detection result obtained in the detecting portion 214, and records the data on the position of the center of gravity of the manipulating body thus calculated in the center-of-gravity position storing portion 245 (Step S110). The center-of-gravity position calculating portion 240 calculates the position of the center of gravity of the manipulating body based on the electrostatic capacitance, in the effective area, which has the value equal to or larger than the predetermined value, and which is detected by the detecting portion 214.

At this time, for example, as shown in FIG. 2, the center-of-gravity position calculating portion 240 may calculate the position of the center of gravity in the entire effective area including both the portion 122a corresponding to the shape of the manipulating body, and the portion 122b corresponding to the shape of the key. Or, when the electrostatic capacitance values which are uniformly distributed on the keys are used for the calculation of the position of the center of gravity as they are, there is the possibility that the sensitivity is especially reduced for detection of the movement of the manipulating body on the same key. In order to cope with this situation, the electrostatic capacitance value of the portion 122b corresponding to the shape of the key is arbitrarily weighted to reduce an influence exerted on the calculation of the position of the center of gravity, thereby making it possible to avoid the reduction of the sensitivity for detection of the movement of the manipulating body. The center-of-gravity position calculating portion 240 records the data on the position of the center of gravity thus calculated in the center-of-gravity position storing portion 245, and outputs the data to the movement amount calculating portion 250.

After that, the movement amount calculating portion 250 calculates the amount of movement from the last position of the center of gravity of the manipulating body to the current position of the center of gravity (Step S112). The movement amount calculating portion 250 searches whether or not the data on the last position of the center of gravity of the manipulating body is recorded in the center-of-gravity position storing portion 245 by referring to the center-of-gravity position storing portion 245. When the data on the last position of the center of gravity of the manipulating body is recorded in the center-of-gravity position storing portion 245, the movement amount calculating portion 250 calculates both the movement direction and movement amount of the manipulating body. On the other hand, when the data on the last position of the center of gravity of the manipulating body is not recorded in the center-of-gravity position storing portion 245, the movement amount calculating portion 250, for example, sets the movement amount as zero. Also, the display processing portion 260 moves the cursor being displayed on the display portion 265 in accordance with the movement amount calculated by the movement amount calculating portion 250 (Step S114). The cursor being displayed on the display portion 265 can be moved in accordance with the operation for moving the manipulating body on the surface of the manipulating block in the manner described above.

Showing a concrete case in FIG. 7, firstly, it is supposed that the user causes his/her finger F as the manipulating body to contact a front side (user side) on an “F” key 110f. At this time, the cursor being displayed on the display portion 265 is located in a cursor position 262a. After that, the user makes tracing on the surface of the manipulating body with his/her finger F so as to draw a curve, thereby moving the finger F to a back side (a side away from the user) on a “J” key 110j located on the right-hand side of the “F” key 110f. For this period of time, the processing from Step S100 to Step S114 of FIG. 6 is repeatedly executed. Thus, the movement amount of cursor being displayed on the display portion 265 is calculated at predetermined intervals, and the cursor being displayed on the display portion 265 is moved. As a result, the cursor being displayed on the display portion 265 is moved from a cursor position 262a to a cursor position 262b so as to draw a curve in accordance with such an operation as to draw the curve with the finger F.

By using the input device 100 of the embodiment in such a manner, it is possible to carry out the pointing manipulation for moving the cursor utilizing the surface of the manipulating block. In addition, only when the manipulating body contacts the desired key, and does not depress the desired key for the period of time equal to or longer than the predetermined period of time, it is possible to carry out the pointing manipulation using the input device 100. As a result, when the hand is made to either come close to or contact the desired key in the case where the user desires to carry out the key manipulation, it is reduced that the cursor is moved in accordance with such an operation. As a result, it is possible to prevent the reduction of the manipulability of the key input. It should be noted that even in a state in which the input device 100 functions as the section for carrying out the pointing manipulation, for example, by depressing any of the keys 110, the input device 100 does not function as the section for carrying out the pointing manipulation and thus can be used as the input section for carrying out the normal key input.

### Manipulating Method Corresponding to State of Manipulating Body

In the input device 100 of the embodiment, the distance between the finger as the manipulating body and the key 100 is detected by the touch sensor 120, thereby making it possible to grasp the state of the finger of the contact portion and the non-contact portion with the key 110. For this reason, with the cursor manipulating method of the another embodiment described above using the input device 100 of the embodiment, by detecting the state of the finger as the manipulating body, the input manipulation can also be carried out by a gesture. For example, the manipulation contents associated with the gesture concerned are carried out by carrying out the gesture to move the non-contact portion of the finger in a state in which a part of the finger contacts the desired key 110. As a result, it is possible to further enhance the manipulability by the input device 100.

In addition, with the input device 100 of the embodiment, the touch sensor 120 can also detect the number of manipulating bodies each contacting the surface of the manipulating block. As a result, as with the case where the processing mode is changed over to another one in accordance with the number of manipulating bodies each contacting the surface of the manipulating block or the like, the processing which can be inputted by carrying out the pointing manipulation or the input manipulation made by the gesture can be diversified.

### (1) Manipulation by Gesture

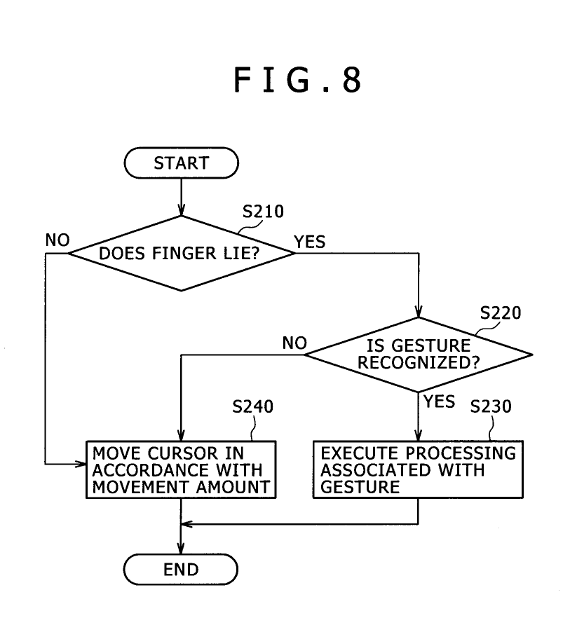

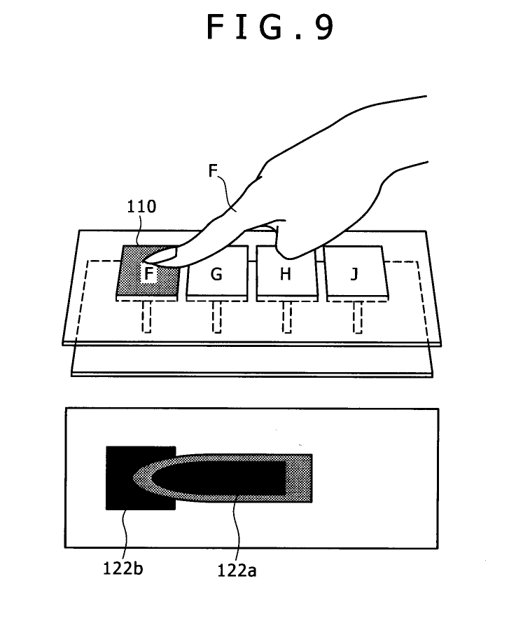

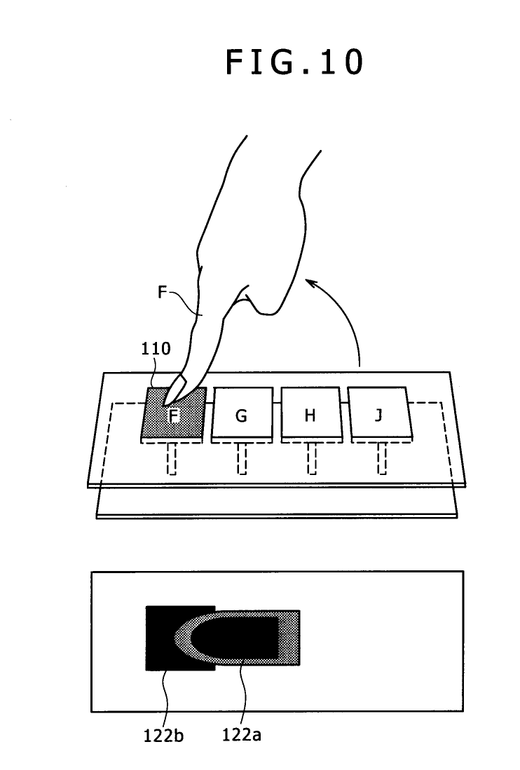

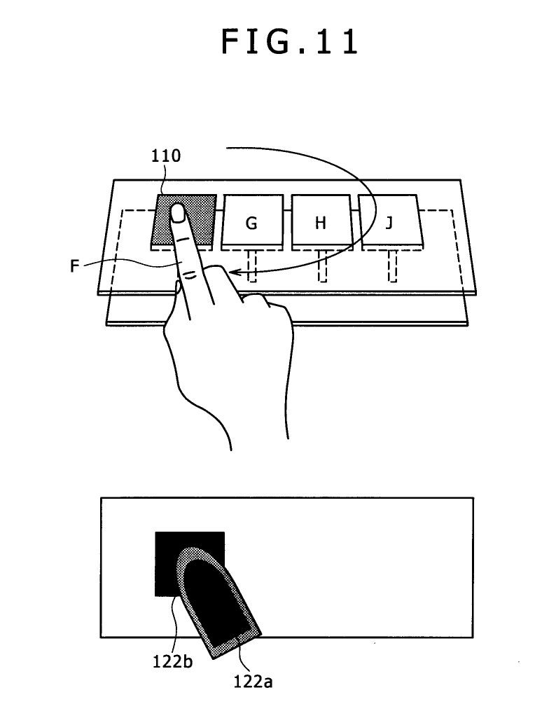

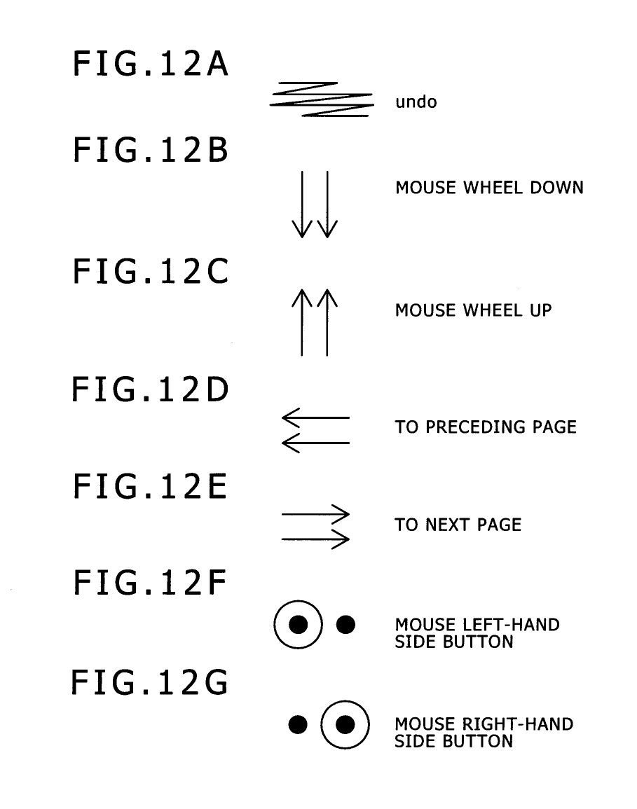

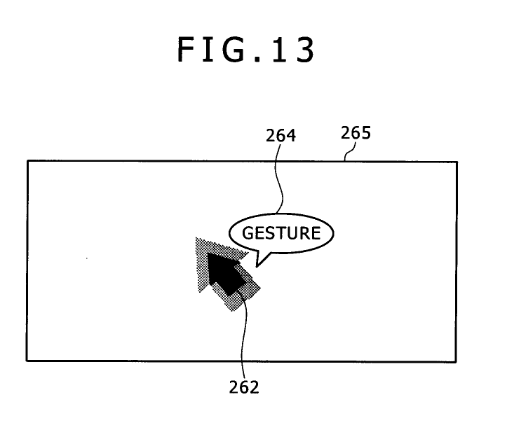

A manipulation by the gesture will firstly be described as a manipulating method corresponding to a state of the manipulating body with reference to FIGS. 8 to 13. Note that, FIG. 8 is a flow chart showing a manipulating method corresponding to the state of the manipulating body in the embodiment. FIG. 9 is an explanatory view showing a state of electrostatic capacitances in a state in which the finger horizontally contacts the desired key. FIG. 10 is an explanatory view showing a state of electrostatic capacitances in a state in which the finger vertically contacts the desired key. FIG. 11 is an explanatory view showing a state of electrostatic capacitances in a state in which the finger is rotated. FIGS. 12A to 12G are respectively explanatory diagrams showing examples of the gesture. Also, FIG. 13 is an explanatory diagram showing an example of display of the cursor in a phase of a gesture mode.

Processing of the flow chart shown in FIG. 8 is executed as processing following the processing of Step S112 in the flow chart shown in FIG. 6. That is to say, in this case, the flow chart of FIG. 8 shows the manipulating method in which the input device 100 is used not only as the input section for carrying out the key input, and the input section for carrying out the pointing manipulation, but also as an input section for carrying out a manipulation by the gesture.

Firstly, after the movement amount calculating portion 250 calculates the amount of movement from the last position of the center of gravity to the current position of the center of gravity of the manipulating body in Step S112 of FIG. 6, the inclination determining portion 270 determines whether or not the finger horizontally contacts the desired key (that is, the finger lies on the surface of the desired key 110) (Step S210). In general, when a human being carries out touch typing for the desired key 110 of the keyboard, he/she necessarily holds up his/her finger for the surface of the desired key 110. The reason for this is because it is feared that when the human being horizontally touch the surface of the desired body 110, he/she cannot apply a pressure against the desired key 110, and thus depresses the key 110 adjacent to the key 110 desired to be depressed by mistake. In the another embodiment, by using such a feature, it is determined whether or not the user desires not to carry out the input manipulation by depressing the desired key, but to carry out the input manipulation by the gesture using the input device 100.

The inclination determining portion 270 determines a state of the finger as the manipulating body based on the two-dimensional information, about the electrostatic capacitances, which is created based on the detection result obtained in the detecting portion 214. For example, with regard to the two-dimensional information about the electrostatic capacitances in a state in which the finger lies on the surface of the manipulating block, as shown in FIG. 9, a portion 122a showing the shape of the finger F, and a portion 122b showing the shape of the “F” key which the finger F contacts are both shown as the effective area. At this time, since the portion in which the finger F comes close to the desired key 110 has a large area, as shown in FIG. 9, the portion 122a showing the shape of the finger F appears in the form of a long form. On the other hand, for example, with regard to the two-dimensional information about the electrostatic capacitances in a state in which the finger is held up, as shown in FIG. 10, the portion 122a showing the shape of the finger F, and the portion 122b showing the shape of the “F” key which the finger F contacts are both shown as the effective area. At this time, since the portion in which the finger F comes close to the desired key 110 has a small area, as shown in FIG. 10, the portion 122a showing the shape of the finger F appears in the form of a short form.

Whether or not the finger F lies on the surface of the manipulating block can be determined from the shape of the finger F in the effective area which is grasped from the two-dimensional information. For example, when a longitudinal length of the shape of the finger F in the effective area is equal to or larger than a predetermined length, it is possible to determine that the finger F lies on the surface of the manipulating block. When it is determined in Step S210 that the finger F lies on the surface of the manipulating block (YES in Step S210), it is determined whether or not the gesture is recognized from the motion of the finger F of the user (Step S220).

Whether or not the gesture has been carried out can be recognized by the gesture recognizing portion 280 in accordance with a change in the portion 122a of the shape of the finger F in the two-dimensional information. For example, when a tip of the finger F is clockwise rotated from the state in which the finger F is made to lie as shown in FIG. 9 while the tip of the finger F contacts the desired key 110, although as shown in FIG. 11, the position of the portion 122b of the shape of the desired key 110 on the effective area grasped from the two-dimensional information is not changed, both the shape and position of the portion 122a of the shape of the finger F are changed. As a result, it is possible to recognize that the gesture to rotate the finger F has been carried out.

When the gesture recognizing portion 280 recognizes that the gesture has been carried out in Step S220 (YES in Step S220), processing associated with the gesture is then executed (Step S230). Firstly, the gesture recognizing portion 280 acquires data on the manipulation contents corresponding to the gesture thus recognized from the gesture storing portion 285. Data on a plurality of gestures as shown in FIGS. 12A to 12G, and data on the manipulation contents are stored in the gesture storing portion 285 in relation to each other.

For example, when as shown in FIG. 12A, the user moves his/her finger F in a zigzag manner while the finger F contacts the surface of the desired key 110, it is possible to execute processing for canceling the processing executed right before this gesture. In addition, when as shown in FIG. 12B, the user repeatedly moves his/her finger F from a back side to a front side, mouse wheel down processing can be executed. On the other hand, when as shown in FIG. 12C, the user repeatedly moves his/her finger F from the front side to the back side, mouse wheel up processing can be executed. Moreover, when as shown in FIG. 12D, the user repeatedly moves his/her finger F from the right-hand side to the left-hand side, processing for a movement to a preceding page can be executed. On the other hand, when as shown in FIG. 12E, the user repeatedly moves his/her finger F from the left-hand side to the right-hand side, processing for a movement to a next page can be executed. In addition, when as shown in FIG. 12F, the user taps his/her left-hand side finger F on the desired key 110 while his/her two fingers F contact the desired key 110, processing for depressing the mouse left-hand side button can be executed. On the other hand, when as shown in FIG. 12G, the user taps his/her right-hand side finger F on the desired key 110 while his/her two fingers F contact the desired key 110, processing for depressing the mouse right-hand side button can be executed.

When the gesture recognizing portion 280 acquires the data on the manipulation contents corresponding to the gesture thus recognized, the gesture recognizing portion 280 outputs the data on the manipulation contents to each of the movement amount calculating portion 250 and the display processing portion 260. When the movement amount of position of the center of gravity of the manipulating body is necessary for carrying out the manipulation contents, after the movement amount calculating portion 250 calculates the movement amount, the display processing portion 260 executes the display processing corresponding to the manipulation contents. On the other hand, when the movement amount of position of the center of gravity of the manipulating body is unnecessary for carrying out the manipulation contents, the display processing portion 260 directly executes the display processing corresponding to the manipulation contents. At this time, for the purpose of informing the user of that a current operation mode is a gesture mode, for example, as shown in FIG. 13, a gesture icon 264 may be displayed in the vicinity of the cursor 262.

It is noted that either when it is determined in Step S210 that the finger F does not lie on the surface of the manipulating block (NO in Step S210), or when the gesture recognizing portion 280 does not recognize the gesture in Step S220 (NO in Step S220), the normal pointing manipulation is carried out (Step S240).

The manipulating method with which the input manipulation by the gesture can be carried out, and which corresponds to the state of the manipulating body has been described so far. As a result, the various kinds of information can be inputted by using the input device 100.

### (2) Change of Processing Mode in Pointing Manipulation

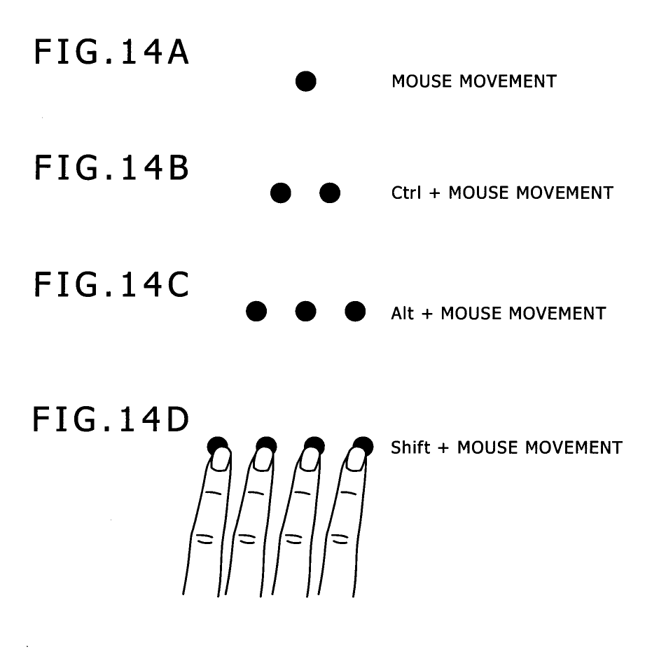

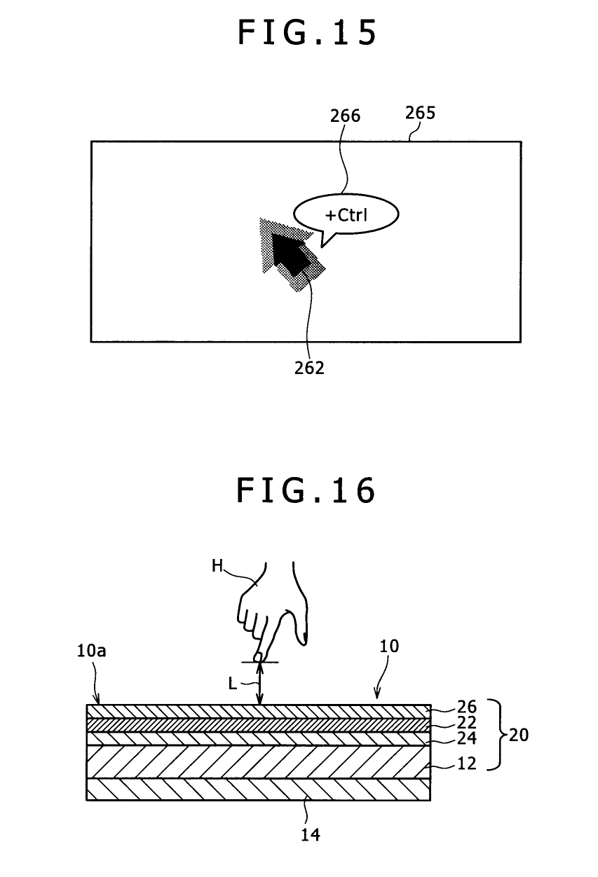

With the input device 100 of the embodiment, as shown in FIGS. 12F and 12G, a plurality of fingers can be detected. Thus, the display processing portion 260 can also change the processing mode in the pointing manipulation in accordance with the number of fingers each contacting the surface of the manipulating block. Hereinafter, a description will be given with respect to the change of the processing mode in the pointing manipulation with reference to FIGS. 14A to 14D, and FIG. 15. It is noted that FIGS. 14A to 14D are respectively explanatory diagrams showing examples of an operation of a cursor mode, and FIG. 15 is an explanatory diagram showing an example of display of the cursor in a phase of the cursor mode.

As previously stated, the pointing manipulation using the input device 100 of the embodiment can be carried out when the manipulating body contacts the desired key 110, and does not depress the desired key 110 for the period of time equal to or longer than the predetermined period of time. At this time, the display processing portion 260 changes the processing mode over to another one in accordance with the number of manipulating bodies each contacting the desired key 110.

For examples, when as shown in FIG. 14A, the number of fingers manipulating bodies each contacting the desired key 110 is one, the normal processing for moving the mouse is executed, and thus only the movement of the cursor being displayed on the display portion 265 is carried out. Next, when as shown in FIG. 14B, the number of fingers as manipulating bodies each contacting the desired key 110 is two, the processing is executed so as to obtain a state in which the mouse is moved while a Ctrl key is depressed. In addition, when as shown in FIG. 14C, the number of fingers as manipulating bodies each contacting the desired key 110 is three, the processing is executed so as to obtain a state in which the mouse is moved while an Alt key is depressed. Also, when as shown in FIG. 14D, the number of fingers as manipulating bodies each contacting the desired key 110 is four, the processing is executed so as to obtain a state in which the mouse is moved while a Shift key is depressed.

As has been described, the processing mode in the pointing manipulation is changed over to another one in accordance with the number of manipulating bodies each contacting the surface of the manipulating block. As a result, the manipulations, for example, as shown in FIGS. 14B to 14D, with which heretofore, the two manipulations of the depressing of the desired key 110, and the movement of the mouse need to be carried out in parallel with each other can be simplified. At this time, the processing mode in the pointing manipulation is displayed on the display portion 265, thereby making it possible to inform the user of the operation state. For example, as shown in FIG. 15, the processing mode icon 266 is displayed in the vicinity of the cursor 262, thereby making it possible to inform the user of the operation state. The processing mode icon 266 shown in FIG. 15 represents that the processing is executed so as to obtain a state in which the mouse is moved while the Ctrl key shown in FIG. 14B is depressed.

The input device 100 according to the embodiment of the present invention, and the input manipulating method according to the another embodiment of the present invention using the same have been described so far. According to the embodiments of the present invention, the touch sensor 120 is provided which can detect that the manipulating body either comes close to or contacts the surface of the manipulating block, whereby the input device 100 can be used not only as the input section by the key input, but also as the section for carrying out the pointing manipulation. Thus, the area saving and miniaturization of the input device 100 can be realized because the two manipulating sections can be physically disposed in the same space. In addition, the manipulability for the user can be made easy because the cursor can be manipulated by only the contact with the desired key 110. In addition, the input device 100 is caused to function as the section for carrying out the pointing manipulation only when the manipulating body contacts the desired key 110 and does not depress the desired key 110 for the period of time equal to or longer than the predetermined period of time. In the manner as described above, it is discriminated whether the user intends to carry out the key input, or intends to carry out the pointing manipulation, whereby the pointing manipulation can be carried out without reducing the manipulability for the normal key input.

In addition, the touch sensor is provided which can detect that the manipulating body either comes close to or contacts the surface of the manipulating block, whereby it is possible to detect the motion (gesture) of the manipulating body, and the number of manipulating bodies each contacting the surface of the manipulating block. As a result, in addition to the simple cursor moving manipulation, the various kinds of processing can be executed.

Although the preferred embodiments of the present invention have been described in detail so far with reference to the accompanying drawings, the present invention is by no means limited thereto. It is obvious that the person having the normal knowledge in the technical field to which the present invention belongs can think of various changes and modifications within the scope of the technical idea described in the appended claims, and it is understood that the various changes and modifications, of course, belong to the technical scope of the present invention.

For example, although in the embodiments described above, proceeding to the gesture mode is determined in accordance with the determination about whether the finger as the manipulating body lies on the surface of the manipulating block, the present invention is by no means limited thereto. For example, whether or not the pointing manipulation can be carried out may be determined in accordance with the state of the finger as the manipulating body. In the cursor manipulating method using the input device 100 of the embodiment described above, the user places his/her finger on the desired key in the contact state for the purpose of carrying out the key input in some cases. At this time, unless the user depresses the desired key for the predetermined period of time with his/her finger, the input portion 212 functions as the section for carrying out the pointing manipulation, and thus the cursor is moved in accordance with the motion of the finger. The mal-manipulation of the cursor may be caused by such a state. In order to cope with such a situation, for example, the shape detecting portion 220 determines whether or not the pointing manipulation can be carried out in accordance with the state of the finger as the manipulating body, thereby making it possible to prevent the mal-manipulation of the cursor from being caused.

The present application contains subject matter related to that disclosed in Japanese Priority Patent Application JP 2009-092403 filed in the Japan Patent Office on Apr. 6, 2009, the entire content of which is hereby incorporated by reference.

What is claimed is:

1. An input device, comprising:
a manipulating block including an electrostatic capacitance detecting portion configured to detect a proximal distance to a manipulating body in accordance with a change in electrostatic capacitance, said electrostatic capacitance detecting portion being provided between a base and a plurality of keys composed of conductive members disposed on said base and being electrically connected to each of said plurality of keys;
a shape detecting portion configured to detect an effective area having an electrostatic capacitance having a value equal to or larger than a predetermined value in accordance with an electrostatic capacitance value detected by said electrostatic capacitance detecting portion, and detect a shape of said key having data stored in advance from the effective area;
a determining portion configured to determine whether or not said key which said manipulating body contacts is depressed for a period of time equal to or longer than a predetermined period of time when the shape of said key is detected from the effective area by said shape detecting portion; and
a display processing portion configured to move an object being displayed on a display portion in accordance with a motion of said manipulating body which contacts a surface of said manipulating block to move when said key is not depressed for the period of time equal to or longer than the predetermined period of time.

2. The input device according to claim 1, further comprising:
a center-of-gravity position calculating portion configured to calculate a position of a center of gravity of the effect area; and
a movement amount calculating portion configured to calculate a movement amount of position of the center of gravity,
wherein said display processing portion moves said object being displayed on said display portion in accordance with the movement amount thus calculated.

3. The input device according to claim 2, wherein said shape detecting portion further detects a shape of said manipulating body from the effective area, and said center-of-gravity position calculating portion calculates a position of a center of gravity in the shape portion, of said manipulating body, of the effective area.

4. The input device according to claim 1, further comprising
an inclination determining portion configured to determine a degree of inclination of said manipulating body with respect to the surface of said manipulating block from the shape of said manipulating body detected by said shape detecting portion,
wherein said display processing portion moves said object being displayed on said display portion in accordance with a motion of said manipulating body which contacts the surface of said manipulating block to move when said inclination determining portion determines that the inclination of said manipulating body with respect to the surface of said manipulating block has a value equal to or smaller than a predetermined value.

5. The input device according to claim 4, further comprising:
a gesture recognizing portion configured to recognize a gesture from a change in state of said manipulating body acquired from detection results obtained in said electrostatic capacitance detecting portion and said shape detecting portion, respectively; and
a gesture storing portion configured to store therein data on the gesture and data on manipulation contents in accordance with which contents being displayed on said display portion are manipulated in relation to each other,
wherein when said gesture recognizing portion recognizes the gesture from the change in state of said manipulating body, said gesture recognizing portion acquires the data on the manipulation contents corresponding to the gesture thus recognized from said gesture storing portion, and outputs the data on the manipulation contents thus acquired to said display processing portion, and
said display processing portion processes the contents being displayed on said display portion in accordance with the data on the manipulation contents inputted thereto from said gesture recognizing portion.

6. The input device according to claim 1, wherein:
said shape detecting portion detects the number of manipulating bodies each contacting the surface of said manipulating block; and
said display processing portion changes a processing mode when said object being displayed on said display portion is moved in accordance with the number of manipulating bodies detected by said shape detecting portion.

7. An input processing method, comprising the steps of:
detecting an electrostatic capacitance by an electrostatic capacitance detecting portion configured to detect a proximal distance to a manipulating body in accordance with a change in electrostatic capacitance, said manipulating body either coming close to or contacting a surface of a manipulating block including said electrostatic capacitance detecting portion provided between a base and a plurality of keys composed of conductive members disposed on said base and electrically connected to each of said plurality of keys, thereby changing the electrostatic capacitance;
detecting an effective area having the electrostatic capacitance having a value equal to or larger than a predetermined value in accordance with the value of the electrostatic capacitance detected by said electrostatic capacitance detecting portion;
detecting a shape of the key having data stored in advance from the effective area;
determining whether or not when the shape of said key is detected from the effective area, said key which said manipulating body contacts is depressed for a period of time equal to or longer than a predetermined period of time; and
moving an object being displayed on a display portion in accordance with a motion of said manipulating body which contacts the surface of said manipulating block to move when said key is not depressed for the period of time equal to or longer than the predetermined period of time.

8. An input device, comprising:
manipulating means including electrostatic capacitance detecting means for detecting a proximal distance to a manipulating body in accordance with a change in electrostatic capacitance, said electrostatic capacitance detecting means being provided between a base and a plurality of keys composed of conductive members disposed on said base and being electrically connected to each of said plurality of keys;
shape detecting means for detecting an effective area having an electrostatic capacitance having a value equal to or larger than a predetermined value in accordance with an electrostatic capacitance value detected by said electrostatic capacitance detecting means, and detecting a shape of said key having data stored in advance from the effective area;
determining means for determining whether or not said key which said manipulating body contacts is depressed for a period of time equal to or longer than a predetermined period of time when the shape of said key is detected from the effective area by said shape detecting means; and
display processing means for moving an object being displayed on display means in accordance with a motion of said manipulating body which contacts a surface of said manipulating means to move when said key is not depressed for the period of time equal to or longer than the predetermined period of time.
